(19) United States
(12) Patent Application Publication
(10) Pub. No.: US 2008/0025810 A1
(43) Pub. Date: Jan. 31, 2008

(54) Wire Threaded Insert Made of Magnesium or Aluminium Alloy

(76) Inventor: Klaus Friedrich Grubert, Buckeburg (DE)

Correspondence Address: SEYFARTH SHAW LLP, 131 S. DEARBORN ST., SUITE2400, CHICAGO, IL, 60603-5803, US

(21) Appl. No.: 11/628,398

(22) PCT Filed: Jun. 15, 2005
(86) PCT No.: PCT/EP05/06445

§ 371 Date: Mar. 2, 2007

(30) Foreign Application Priority Data
Jun. 15, 2004 (DE) 20 2004 009 409.6

(51) Int. Cl. F16B 37/12; F16B 13/04

(52) U.S. Cl. 411/16

(57) ABSTRACT

Wire thread insert comprising a helically coiled wire member for being inserted into a threaded bore of a structural member, which wire member is made of a high-strength hardenable aluminium forging alloy of series 6000-Al—Mg—Si without any contact corrosion influencing surface coating.

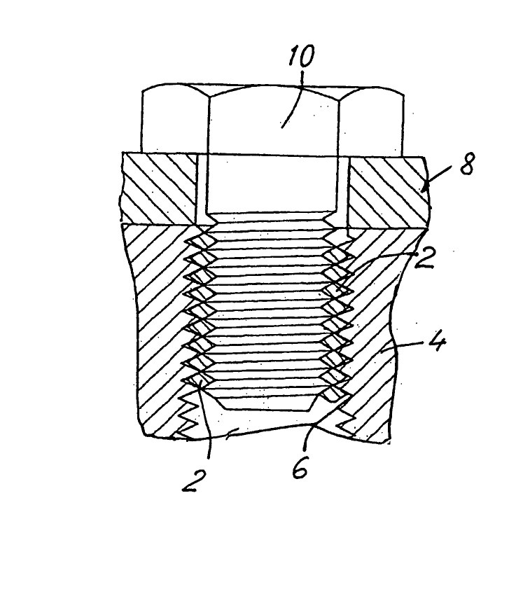

### DESCRIPTION

The present invention relates to a wire thread insert made of a helically coiled wire member for being inserted into a threaded bore of a structural member.

Such wire thread inserts are used to increase the loading capacity of threads in structural members of low strength or when performing repairs on damaged threads. They therefore need to be of correspondingly high strength and are normally made of steel. One of the difficulties encountered in using steel wire thread inserts involves the steel's tendency to contact corrode with certain internal thread materials and gall with certain screw materials.

Wire thread inserts made of steel and provided with fluoropolymer coatings to increase their resistance to contact corrosion are known from EP 1 070 860. EP 1 122 449 proposes the use of a special nitrogen-strengthened stainless steel alloy as the material for wire thread inserts in order to increase their resistance to galling.

To impede contact corrosion between wire thread inserts and structural members made of cast magnesium alloy, it is already known to anodize or treat the surface of a high-strength aluminium forging alloy (AlZnMgCu 1.5) as the material for the wire thread insert in an anodic oxidation process so that an aluminium oxide layer (hard coat) forms on the surface. The hard coat surface is electrically insulating, thus preventing contact corrosion between the base material of the wire thread insert and the cast magnesium alloy of the structural member. This solution has the additional advantage of the hard coat surface providing a galvanic separation between a steel screw and the structural member made of the cast magnesium alloy.

One disadvantage of the above-described solutions is the relatively high expenditure involved in the surface treatment, the coating of the wire thread inserts respectively, in order to increase their resistance to contact corrosion.

The object of the present invention is that of providing a wire thread insert of a material which does not require complex post-treatment and yet is resistant to contact corrosion, in particular with respect to structural members made of cast magnesium and aluminium alloys.

According to one solution of the invention, the wire member consists of a high-strength hardenable aluminium forging alloy of series 6000 Al—Mg—Si without any contact corrosion influencing surface coating. Aluminium forging alloys such as AlSilMgCuMn (EN AW6056) are preferred, although other high-strength hardenable aluminium forging alloys of the 6000 series can be used as well.

These materials have proven surprisingly suitable for wire thread inserts for use in structural members in particular of cast magnesium alloys, but also of cast aluminium alloys. They have the advantage of being altogether resistant to corrosion and in particular resistant to stress crack corrosion without needing to be provided with a separate contact corrosion influencing surface coating. Unlike the wire thread inserts made of aluminium forging alloys having a hard coat surface as described above, the wire thread inserts configured according to the invention do have the disadvantage of there being no galvanic separation between the structural members made of a cast magnesium alloy and screws made of steel alloys. Yet on the whole, the wire thread inserts according to the invention are characterized by high cost-effectiveness since they do not need to be provided with a contact corrosion influencing surface coating. In addition, such aluminium forging alloys exhibit a relatively high thermal conductivity relative to steel, for example, which is of special advantage for certain applications as will be described in greater detail below.

According to another solution of the invention, the wire member of the wire thread insert consists of a magnesium forging alloy without a contact corrosion influencing surface coating. Particularly applicable here would be magnesium forging alloys such as MgAl3Zn (AZ31) and MgAl6Zn (AZ61).

Despite the known brittleness of magnesium, magnesium forging alloys have shown to be surprisingly suitable for use in wire thread inserts in structural members of magnesium in particular. Magnesium forging alloys have the particular advantage of being resistant to contact corrosion as a whole and in particular resistant to stress crack corrosion without requiring a special surface treatment or coating. A further advantage of magnesium forging alloys resides in the fact that sufficient tensile strength of the wire member can be attained just from strain hardening alone when manufacturing the wire thread insert without the wire thread insert needing to be tempered. Magnesium forging alloys additionally have the advantage of low weight as well as high thermal conductivity, which is advantageous for certain applications.

Advantageous further developments and designs of the invention are indicated in the subclaims.

The following will make reference to the sole FIGURE of the drawing schematically showing a screw connection having a wire thread insert in describing exemplary embodiments of the invention in greater detail.

The wire thread insert 2 shown in the FIGURE typically consists of a helically coiled wire member which is inserted into a threaded bore 6 of a structural member 4 in order to increase the loading capacity of the thread of the threaded bore 6. A screw 10 is inserted into the wire thread insert 2 which serves to brace a structural member 8 to the structural member 4.

As described above, according to one solution of the invention, the wire member of the wire thread insert 2 consists of a high-strength hardenable aluminium forging alloy of series 6000 Al—Mg—Si without a contact corrosion influencing surface coating. High-strength hardenable aluminium forging alloys such as AlSilMgCuMn (EN AW6056) are preferred. Such aluminium forging alloys of the 6000 series are alloys with low copper content (Cu<1%), which are resistant in particular to corrosion of magnesium die cast alloys such as e.g. AZ91.

In order to increase the tensile strength of the wire thread insert 2 to values greater than 400 N/mm², the wire thread insert 2 is subjected to the corresponding tempering. Before the wire thread insert 2 is inserted into the receiving bore 6, it is expediently provided with a dry gliding film. This is a wax-like substance, in particular a substance containing polyethylene, which reduces the thread friction between the wire thread insert 2 and the thread of the threaded bore 6 on the one hand and the thread of the screw 10 on the other during assembly.

As mentioned above, wire thread inserts made of such aluminium forging alloys are particularly suited to increasing the thread loading capacity of structural members made of cast magnesium alloys such as e.g. AZ91. On the one hand, the tensile strength of such wire thread inserts made of aluminium forging alloy (>400 N/mm²) is considerably higher than the basic strength of conventional cast magnesium alloys.

On the other, such aluminium forging alloys have a high corrosion resistance relative to magnesium, since aluminium is close to magnesium in the element series.

Wire thread inserts made of the indicated aluminium forging alloys can be used not only to increase thread loading capacity, but also to repair damaged threads. A special application is the fixing of steel spark plugs in threaded bores of aluminium cylinder heads.

When prior art threaded bores of such a cylinder head were damaged, repair would entail inserting a wire thread insert made of a special stainless steel into the corresponding drilled threaded bore. Since steel has low thermal conductivity, an undesired change in the spark plug's thermal balance would potentially occur in such cases following repair.

Using wire thread inserts made of the above-cited aluminium forging alloys according to the invention instead of steel wire thread inserts now solves the problem as presented because of the high thermal conductivity of aluminium alloys. There are then no changes in the spark plug's thermal balance.

In this application, wire thread inserts made of aluminium alloys therefore benefit not only from the advantage of high resistance to corrosion and low weight, but also the advantage of high thermal conductivity.

Aluminium alloys are preferable as the material for the screws used with these wire thread inserts, although other materials such as, in particular, special steels can be used for specific applications as well.

According to the second solution of the invention, the wire member of the wire thread insert 2 consists of a magnesium forging alloy without a contact corrosion influencing surface coating. Magnesium forging alloys such as MgAl3Zn (AZ31) and MgAl6Zn (AZ61) are preferred.

These materials allow a tensile strength of greater than 350 n/mm² to be attained when manufacturing the wire thread insert just from strain hardening alone without any tempering being required. In this solution of the invention, the wire thread insert is also provided with a dry gliding film in order to achieve optimum thread friction behavior for the wire thread insert during assembly.

Despite magnesium's inherent brittleness, wire thread inserts made of the cited magnesium forging alloys have shown to be surprisingly suitable as the material for wire thread inserts. Of special advantage is the use of wire thread inserts made of such magnesium forging alloys combined with structural members of cast magnesium alloys such as e.g. AZ91, as is applicable to many technical fields today. The problem of contact corrosion is by nature wholly avoided with this material combination. Since neither is any surface coating nor tempering necessary for these wire thread inserts, this solution of the invention is characterized by high cost-effectiveness.

Wire thread inserts made of the cited magnesium forging alloys can be used in turn both to increase the thread loading capacity for structural members made of a material of low strength as well as to repair damaged threaded bores.

Aluminium alloys are primarily preferable for the material of the screws used together with these wire thread inserts, although other materials such as steel can be used as well.

1. A structural member including a wire thread insert made of helically coiled wire member inserted into a threaded bore of the structural member, wherein the wire member is made of a high-strength hardenable aluminium forging alloy of series 6000 Al-Mg-Si without any contact corrosion influencing surface coating and the structural member is made of a cast magnesium or cast aluminium alloy.

2. The structural member including a wire thread insert of claim 1, wherein the high-strength hardenable aluminium forging alloy is AlSilMgCuMn.

3. The structural member including a wire thread insert according to claim 1, wherein the wire member has been tempered to increase its tensile strength.

4. The structural member including a wire thread insert according to claim 1 wherein the wire member is provided with a dry gliding film.

5. The structural member including a wire thread insert made of a helically coiled wire member inserted into a threaded bore of the structural member, wherein the wire member is made of magnesium forgoing alloy without any contact corrosion influencing surface coating and the structural member is made of a magnesium alloy or aluminium alloy.

6. The structural member including a wire thread insert according to claim 5, wherein the magnesium forging alloy is MgAl3Zn or MgAl6Zn.

7. The structural member including a wire thread insert according to claim 5, wherein the wire member has not been subjected to tempering.

8. The structural member including a wire thread insert according to claim 5, wherein the wire member is provided with a dry gliding film.
